(19) United States
(12) Patent Application Publication
(10) Pub. No.: US 2015/0304388 A1
(43) Pub. Date: Oct. 22, 2015

(54) SYSTEMS AND METHODS FOR MANAGING AND SHARING DATA FROM USER DEVICES

(71) Applicant: Google Inc., Mountain View, CA (US)

(72) Inventors: Michael Jeffrey Procopio, Boulder, CO (US); Robert Brett Rose, Boulder, CO (US)

(73) Assignee: Google Inc., Mountain View, CA (US)

(21) Appl. No.: 14/253,951

(22) Filed: Apr. 16, 2014

(51) Int. Cl. H04L 29/08

(52) U.S. Cl. CPC H04L 67/06

(57) ABSTRACT

Systems and methods are disclosed herein for managing and sharing data that is uploaded from a user device to a web-based storage system. The user may specify one or more sharing settings for the data including other users with whom to share the data. The recipients or other users can specify data feed settings to manage the shared data. Data that is uploaded from the user devices is automatically shared based on the sharing settings for the user and device as well as data feed settings for a recipient.

### FIELD OF THE INVENTION

In general, this disclosure relates to managing and sharing data from user devices using a web-based storage system.

### BACKGROUND

Web-based storage systems are data-hosting systems that allow users to store and retrieve data that may originate and be accessible from one or more user devices. Some users may wish to share such data with other users and other devices. However, controlling the dissemination of the user's data, in particular, for various types of devices may not be intuitive.

### SUMMARY

Systems and methods are disclosed herein for managing the sharing of data uploaded from user devices to a web-based storage system or cloud storage system. In an aspect, a method for sharing data uploaded to a web-based storage system from a plurality of user devices is provided including detecting a connection of a user device to the web-based storage system; determining a sharing setting associated with the user device; uploading data stored on the user device to the web-based storage system; and automatically sharing the uploaded data in accordance with the sharing setting for the user device. User data associated with a user of the web-based storage system is verified using the user device. A communications protocol is established between the user device and an application programming interface (API) for the web-based storage system. The uploaded data is shared based on a sharing setting with a second user. The sharing setting may limit how the uploaded data is shared or not shared and may include a designated recipient, no recipient, a time schedule for sharing uploaded data, require on-demand sharing, or other setting. A recipient of the data or other user that is not an owner or creator of the data may specify data feed settings for handling the uploaded data.

### BRIEF DESCRIPTION OF THE DRAWINGS

The above and other features of the present disclosure, including its nature and its various advantages, will be more apparent upon consideration of the following detailed description, taken in conjunction with the accompanying drawings in which:

FIG. 1 is a block diagram of a computerized system for sharing data on a user device using a web-based storage system, according to an illustrative embodiment.

FIG. 2 is a block diagram of a user device, according to an illustrative embodiment.

FIG. 3 is a flow chart for uploading data stored on a user device to a web-based storage system, according to an illustrative embodiment.

FIGS. 4A and 4B are diagrams of a display of a user interface for registering a user device and specifying sharing settings, according to an illustrative embodiment.

FIG. 5 is a flow chart of an illustrative method for sharing data stored on a user device by uploading the data to a web-based storage system, according to an illustrative embodiment.

FIGS. 6A and 6B are diagrams of a display of a user interface for specifying data feed settings, according to an illustrative embodiment.

### DETAILED DESCRIPTION

To provide an overall understanding of the disclosure, certain illustrative embodiments will now be described, including a system for managing and sharing data uploaded from a user device to a web-based storage system. In particular, a system is described that allows a user to specify types of data to be uploaded from a particular user device to the web-based storage system where the data is stored and made available for sharing with one or more other users or recipients using user and/or user-device sharing settings and the web-based storage system. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. Generally, the computerized systems described herein may comprise one or more engines, which include a processing device or devices, such as a computer, microprocessor, logic device or other device or processor that is configured with hardware, firmware, and software to carry out one or more of the computerized methods described herein.

The present disclosure provides systems and methods for sharing data that is uploaded from one or more user devices to a web-based storage system that can be shared with one or more recipients. A user may have multiple user devices that are capable of capturing data and connecting to a web-based storage system to transmit the captured data. For example, a user may have a home thermostat that can record and report environmental conditions in a home, such as temperature and an alarm system that can record and report break ins, smoke detectors, carbon monoxide detection, or other information. The same user may also have a sports watch that is capable of recording GPS location, distance traveled, time of exercise, heart rate, or other data points. In addition, the user may have a camera for taking photographs. The user may also have a car with a smart monitoring system. All of these user devices, and others, can capture data and connect to a web-based storage system to upload the data. Since many of these devices are proprietary and developed for different consumers, each may have its own user interface with different features and functionality. Controlling data dissemination for each user device can require different inputs and become difficult to manage. Thus, a user may wish to control such data using system that can interface with each device and a web-based storage system so that the user can easily manage and control data for one or more devices that can be shared with one or more different recipients or other users. For example, the user may wish to share home monitoring information with a roommate, spouse, co-owner or neighbor, the sports watch data with a doctor, coach, and teammates, the photographs with friends, and the car data with a mechanic or co-owner. Each of these recipients may also wish to control the receipt of such data. In addition, the user may wish to store the data and decide on whether to share it at a later time, share it in real time, or some specified time period. Accordingly, systems and methods are described herein for facilitating such data sharing.

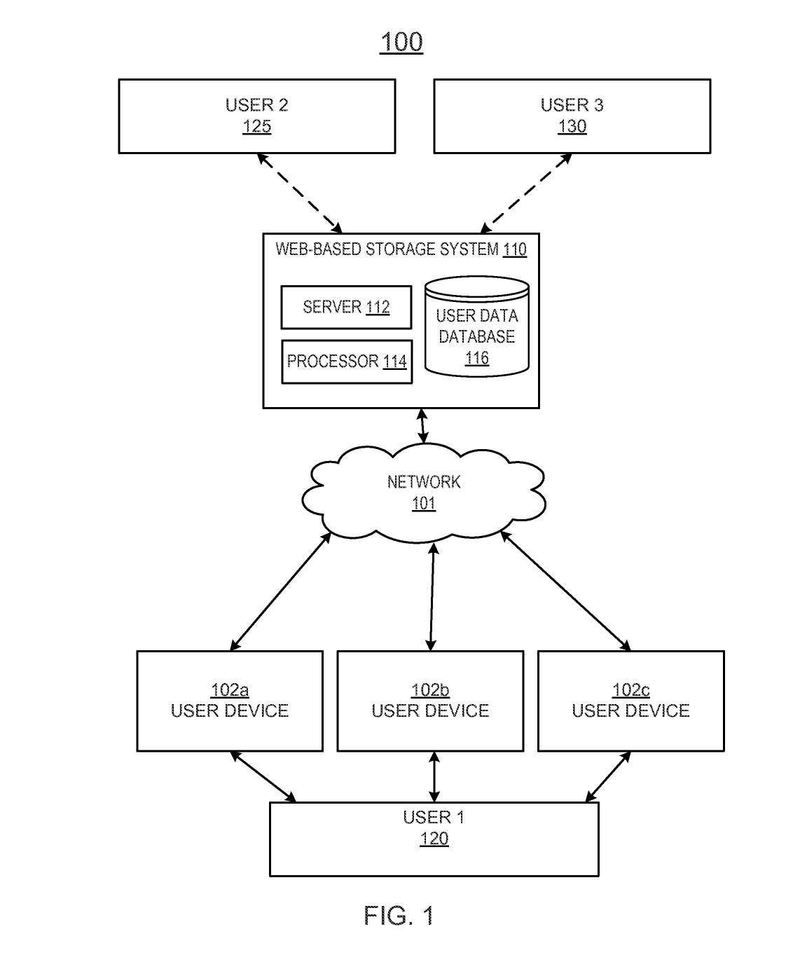

FIG. 1 depicts an example of a network and system that may be used to implement the systems and methods herein. FIG. 1 is a block diagram of a computerized system 100 for allowing data stored on a user device to be uploaded to a web-based storage system. The system 100 includes a web-based storage system 110 and one or more user devices 102a-c, all configured to communicate over a network 101. The user device 102 may be any type of user device that is capable of capturing data for a user, and connecting and saving the data to a cloud storage system. Some types of user devices can include: cameras, mobile devices, tablets, memory card readers, GPS enabled sports watches, scales, vehicle engine management monitoring systems, personal blood pressure measurement devices, personal blood chemistry measurement devices, pedometers, treadmills, smoke and carbon monoxide detectors, hot water heaters, thermostats, environmental monitors, and other devices. Such user devices 102 may include local storage to store data locally. Although only three user devices 102a-c are shown in FIG. 1, a user 120 may have any number of user devices 102. User 120 may be any individual or other entity that has one or more user devices 102 that can upload data to the web-based storage system 110 over network 101.

The web-based storage system 110 includes a server 112, a processor 114, and a user data database 116. As used herein, the term “processor” refers to one or more computers, microprocessors, logic devices, servers, or other devices configured with hardware, firmware, and software to carry out one or more of the computerized techniques described herein. Processors and processing devices may also include one or more memory devices for storing inputs, outputs, and data that are currently being processed. Only one web-based storage system 110 is shown in FIG. 1 to avoid complicating the drawing. In general, the system 100 can support multiple web-based storage systems and user devices.

The web-based storage system 110, sometimes referred to as a cloud storage system, is a file hosting system that allows users to store, retrieve, and modify data. This data may be referred to as a user's web data, which is stored in the user data database 116. The server 112, the processor 114, or both may perform functions related to managing and maintaining the user data database 116, such as allocating memory for the data, receiving new data to be stored in the database, deleting data in the database, and sharing user data in the database. The web-based storage system 110 may be stored on a single server system or in a distributed system. In particular, the web-based storage system 110 may use cloud storage to store user data.

The user device 102 is configured to upload user data into the web-based storage system 110, namely into the user data database 116. In particular, the user device 102 is configured to connect to the web-based storage system 110 using a communications protocol to upload data over the network 101 to the user data database 116. Prior to establishing a connection between the user device 102 and web-based storage system 110, an authentication or account verification procedure may be undertaken to ensure that the data being uploaded is authorized and may require using user device information or a user input in the user device. Data stored on the user device 102 may then be uploaded to the user data database 116. The upload may a copy of the data on user device 102 or a transfer of the data from user device 102 to user data database 116. In either case, the processor 114 may detect whether the upload data already exists in the user data database 116 by, for example, comparing metadata associated with the data, and delete any duplicate files.

The user data database 116 may also be used to store user information, including user preferences, such as sharing settings that may be specified for each particular user device 102. The user may also specify generic sharing settings that may apply globally to any user device 102. The user data database 116 may also include data feed settings for a user, for example another user or recipient of data, such as users 2 and 3 (125, 130), who may receive certain shared data from user 120 via the web-based storage system 110. For example, an athlete may train using a device that tracks heart rate and pace. Such data can be uploaded to the web-based storage system and shared with a coach or teammate. Other teammates may have similar devices that can upload to the web-based storage system and so the coach may wish to aggregate some portion of the data from each athlete. Each individual and each recipient can specify the sharing and data feed settings to streamline the data sharing. In addition, each user and recipient can control the timing of uploads and sharing so that the data can be shared or not shared, shared in real time or shared periodically.

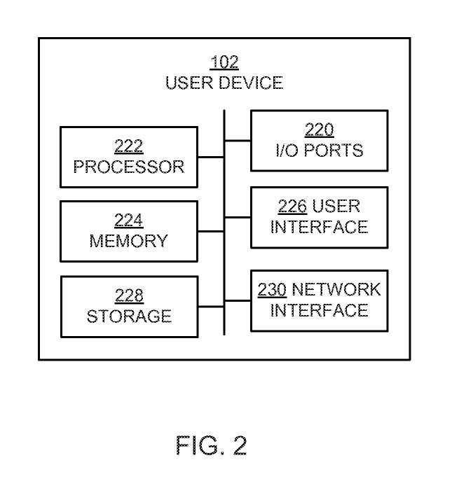

FIG. 2 is a detailed block diagram of the user device 102 shown in FIG. 1, according to an illustrative embodiment of the present disclosure. Since many different types of user devices 102 can be used in the manner described herein, FIG. 2 is meant to show only some generic elements of user devices 102, some of which may not be necessary.

As shown in FIG. 2, the user device 102 includes I/O ports 220, a processor 222, a memory 224, a user interface 226, storage 228, and a network interface 230, all shown in FIG. 2 as being connected over a bus. One or more connections may be made between I/O ports on the user device 102. The user device 102 may be configured communicate data over the I/O port. The user device 102 includes multiple different I/O ports that are configured to connect with any number of devices. The user device 102 may use the I/O ports to capture or record monitoring data, for example, environmental monitoring information for a thermostat, distance traveled for a pedometer, and other data. The I/O ports may also be used to connect to another device for communicating with the web-based storage system.

The user device 102 may include a user interface 226 that can include a display unit and optionally includes a user input unit. In one example, the user interface 226 includes a touch LCD screen that is configured to display settings related to the device and to any upload to the web-based storage system. Depending on the type of device, the user interface can range from a full screen tablet user interface, a smart phone screen, to a few buttons on a watch.

In an example, the display unit of the user interface 226 is accessible from a device other than the user device 102. In an example, the user may access the display unit of the user interface 226 over a web browser on a computer, mobile device, or other user device to control data uploads from the user device 102 to the web-based storage system, as well as communicate with the web-based storage system to specify, for example, sharing settings and data feed settings. The display may be obtained using a wired or unwired connection between the user device 102 and another device.

The network interface 230 of the user device 102 is configured to communicate over one or more networks such as the network 101 shown in FIG. 1 with, for example, the web-based storage system 110. Any communications with the web-based storage system 110 will typically begin with a user authentication procedure, for example providing user account information. In general, since many types of user devices 102 can be used, each may be configured to upload data to any number of different web-based storage systems. As part of a user authentication procedure, a particular web-based storage system may be specified to use for the current upload. In addition, simultaneous uploads of the same or different data to different user accounts on the same web-based storage system or different user accounts on different web-based storage systems are also possible.

For each upload of data from the user device 102, a file folder may be created on the web-based storage system 110. In an example, a new folder may be created for each upload instance. In particular, for each connection of the user device 102 to the web-based storage system, an instruction signal may be transmitted over the network interface 230 to generate a new folder on the user data database 116 that is designated for the anticipated upload. The folder may be nested under another user-specific folder in the user data database 116. For example, the user-specific folder may refer to a portion of the user data database 116 that is associated with the user's account with the web-based storage system 110. The data being uploaded is stored to the recently created folder.

The processor 222 is configured to perform any of the functions described herein as being performed by the user device 102. In particular, the processor 222 may facilitate communications with one or more I/O ports 220 and transmit signals to the network interface 230 to initiate an upload to the web-based storage system 110.

The memory 224 may store instructions readable by the processor to carry out the processes described herein. In an example, the memory 224 may store user data. Alternatively, storage 228 may be used to store user data.

As shown in FIG. 2, the user device 102 includes a processor 222, I/O ports 220, a memory 224, a user interface 226, storage 228 and a network interface 230. In general, the user device 102 may include any subset of the elements shown in FIG. 2, as well as any other additional elements, and any subset of the elements may be combined into a single unit. The complexity of the user device 102 may vary according to the device. In particular, the user interface 226 may be designed to be simple, such as one that only includes a display unit or is configured to receive user input, but not both.

In some embodiments, previous settings from a previous upload are saved (into the memory 224 on the user device 102, for example) and recalled upon initiation of a new upload to the web-based storage system 110. In this case, a user authentication procedure may be avoided, or minimized and data that is stored on the user device 102 is automatically uploaded to the web-based storage system.

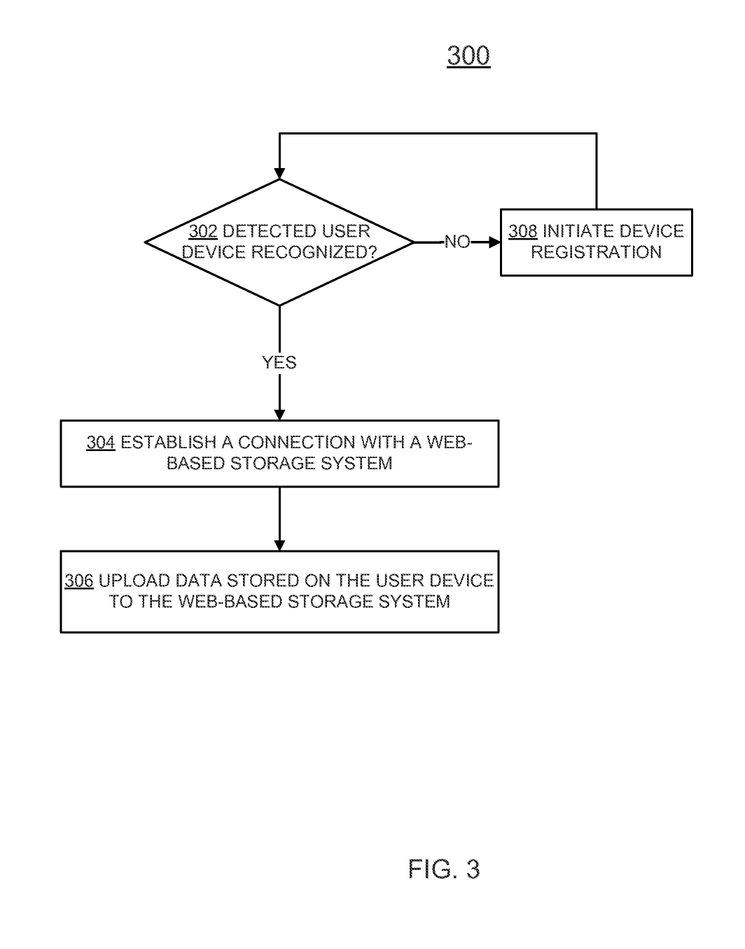

FIG. 3 is a flow chart of an illustrative method 300 for registering a device to be used to share data using a web-based storage system. The method 300 includes the steps of detecting whether a user device 102 is recognized (302), if yes, then establishing a connection with a web-based storage system (304) and uploading data stored on the user device to the web-based storage system (306). If the user device 102 is not recognized, the registration procedure is initiated (308). The order of the steps and decision blocks as shown in FIG. 3 are for illustrative purposes only and one of ordinary skill in the art will understand that any suitable order may be used.

At step 302 a user device 102 may be connected to the web-based storage system 110 using, for example, its network interface 230 and a network 101, or using its ports 220 and some intermediary device. An authentication procedure will be initiated by the web-based storage system 110 when the user device 102 is detected, for example, by the processor 114. The authentication procedure may cause the user device 102 to supply user information to confirm the source of the data. If the user device 102 is recognized, the user device 102 and the web-based storage system 110 will establish a connection at step 304 using, for example, a communications protocol interfacing with an API associated with the web-based storage system 110. For example, the web-based storage system 110 may have an externally facing API, that may be used to interface with the web-based storage system 110 to read from the user device 102 and write data to the user data database 116. At step 306 the data is uploaded from the user device 102 to the web-based storage system. In some scenarios, the upload at step 306 is performed automatically upon detection of a recognized device at step 302 and establishing the communications protocol at step 304.

If, however, at step 302 the user device is not recognized, a device registration procedure may be initiated at step 308. Device registration may be undertaken using the user interface 226 of the user device 102 and communicating device and user information to the web-based storage system. Following registration of the device, the method may return to step 302 and the detected user device is recognized and follows the flow to step 304.

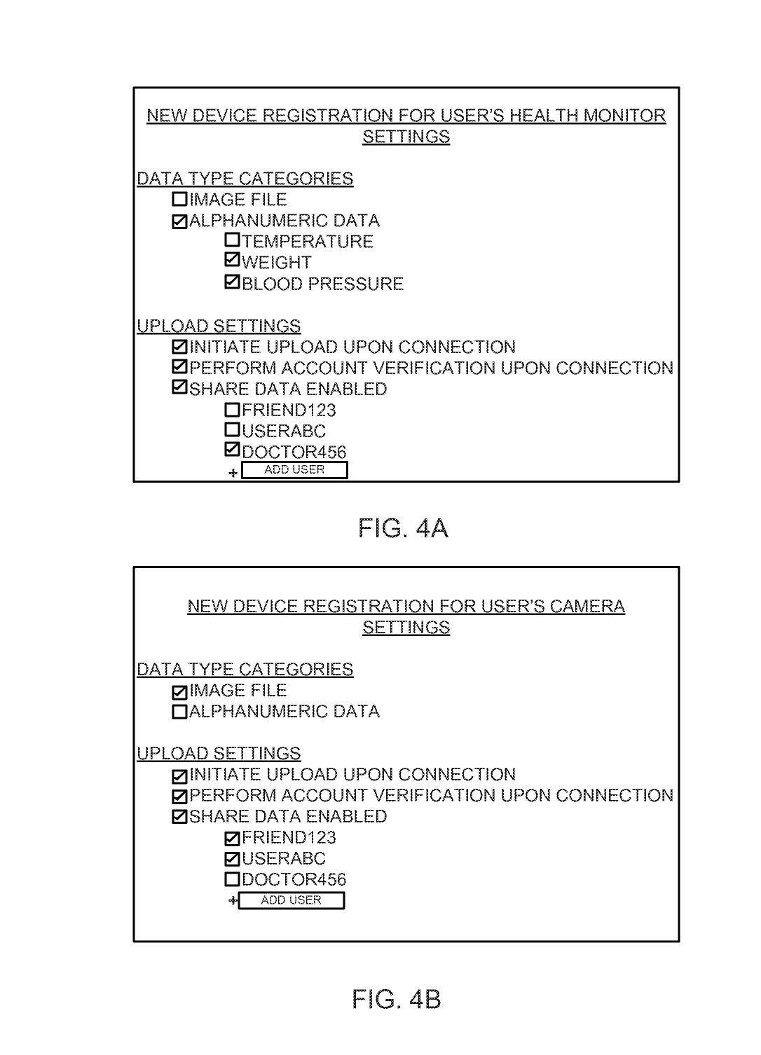

More commonly, device registration may be performed using a computer or mobile device using an interface associated with the web-based storage system to identify a new device. An illustrative diagram of such an interface is shown in FIGS. 4A and 4B.

As shown in FIG. 4A, a user interface for specifying settings for a new device may include identifying information for the device, for example, a health monitor, as well as information about data types and how to handle such data. Different types of devices may be known to the web-based storage system and different relevant choices and options may be provided during the registration process. For the user's health monitor, the user may select that alphanumeric data, in particular weight and blood pressure, for certain upload settings. In this example as shown in FIG. 4A, no such settings are specified for temperature. Some upload settings can include that the data is uploaded upon connection with the web-based storage system, that account verification is performed, and that selected data can be shared with one or more users. Other selections could also be made, including, limitations on how the data can be handled by the users with whom the data is shared, for example, setting certain users as data editors or simply data viewers. In another example as shown in FIG. 4B, a user's camera may have image files uploaded and shared with multiple users. The users with sharing privileges can be changed at anytime.

Data sharing and handling settings can include any number of details, for example, that data is pushed to recipients, data is only available for manual sharing, data is shared on a periodic basis, data is shared when data accumulates to a specified quantity, data is made available to recipients for a limited time period, the data is scrubbed for certain identifying details, duplicate data points are removed, data is bundled and averaged over a time period, or data is processed to avoid outlier data. Data sharing and handling settings can be changed at anytime by the user to revoke sharing privileges, limit subsets of data, require manual sharing or other settings. Such changes can be made on a device basis, or by a global change affecting all of the devices associated with a user.

In some scenarios, if a user device 102 is not registered, its data may be uploaded to the web-based storage system 110 and stored in a file folder associated with a user and designated as private to the user without any data sharing. In addition, a user may have a global user setting that data is private unless specific sharing settings are designated for a user device 102.

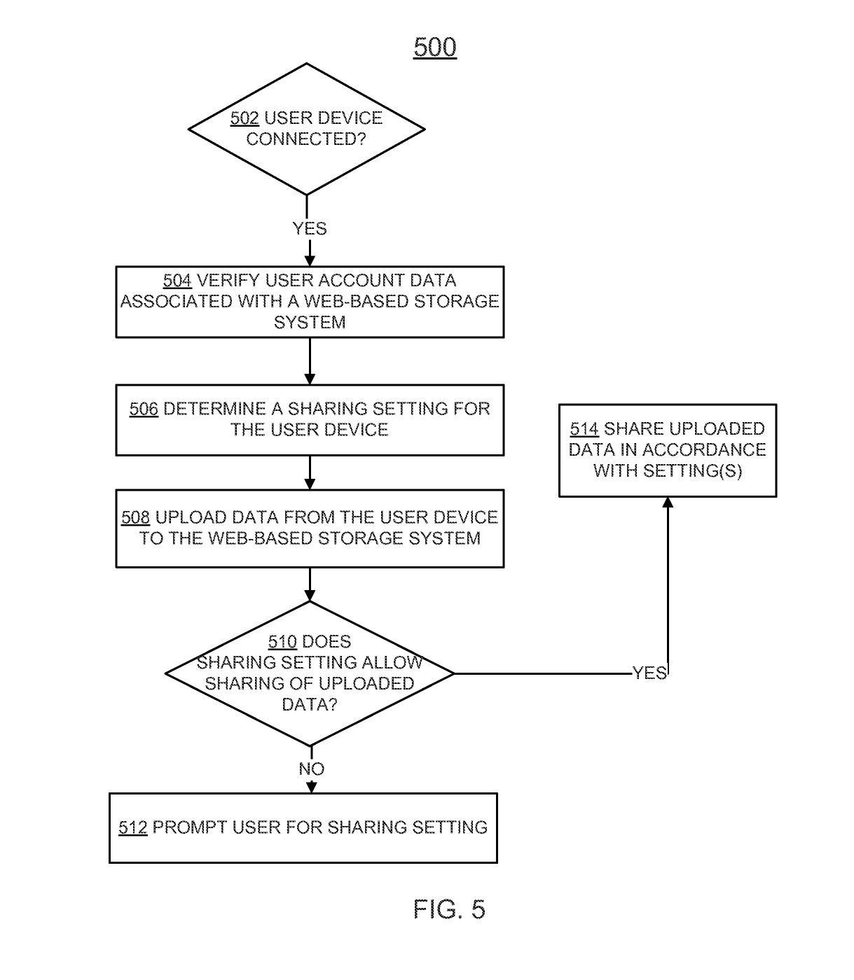

Turning to FIG. 5, the sharing settings specified in the device registration process are used to share data uploads. In some scenarios, sharing settings can be specified on a per-user basis and applied globally to any devices that are associated with the user. In other scenarios, device settings are used to share data. In yet another scenario, both are used. FIG. 5 is a flow chart of an illustrative method 500 for uploading data from a user device to a web-based storage system and sharing the uploaded data using the web-based storage system. The method 500 includes the steps of detecting whether a user device is connected to the web-based storage system (decision block 502), verifying a user account associated with the web-based storage system (504), and uploading data stored on the user device to the web-based storage system (508), determining whether the uploaded data is subject to sharing settings (decision 510), and sharing the data based on sharing settings (512 and 514). The order of the steps and decision blocks as shown in FIG. 5 are for illustrative purposes only and one of ordinary skill in the art will understand that any suitable order may be used.

At step 502, the web-based storage system will detect that a user device 102 is attempting to connect to it. The connection between the user device 102 and the web-based storage system 110 may be over network 101. In general, a communications protocol is established between the user device 102 and the web-based storage system 110. For example, the user device 102 will interface with an externally facing API for the web-based storage system 110. The web-based storage system, upon detection of a user device will initiate an authentication procedure at step 504 to verify the source of the data. The authentication procedure may include requesting user details from the user device 102, which can include requiring a user to enter certain information, or may cause the user device 102 to submit user credentials stored, for example, on user device memory 224. Upon verifying user information for the user device 102, the web-based storage system will determine whether there are sharing settings for the user device at step 506. Such sharing settings may be associated with a user or a user device and may be stored in the user data database 116 for the user. The sharing settings may be relevant to how the data is to be uploaded from the user device. Data stored on user device 102 may be uploaded to the web-based storage system 110 at step 508 in response to detecting the connection of the user device at decision block 502 and verifying the user account at step 504. Data that is uploaded to the web-based storage system 110 may be uploaded to a folder associated with the user in user data database 116.

Following the data upload, the web-based storage system may handle the data in accordance with user-specified sharing settings. At decision block 510, the web-based storage system processor will determine whether the sharing setting for the user device (or the user) allows sharing of the uploaded data. If sharing is permitted, the web-based storage system will make the data available to other users or recipients in accordance with the sharing settings at step 514. If no sharing is allowed, the web-based storage system may optionally ask the user for a sharing setting. In some scenarios, the system may prompt the user to update a device registration to include sharing settings or other data handling details. A user may also have a sharing setting such that there is no automatic sharing and the user may be prompted to manually specify whether uploaded data is to be shared. In another scenario, a user may have automatic sharing with no users so that the data is available for sharing upon manual selection of a recipient.

Data that is uploaded to the web-storage system may be shared according to the sharing settings in real time. In some scenarios, a user may specify that sharing is not performed in real time. For example, the sharing may occur at a certain time, at periodic intervals, when the user manually causes the data to be shared, or when data accumulates to a certain quantity.

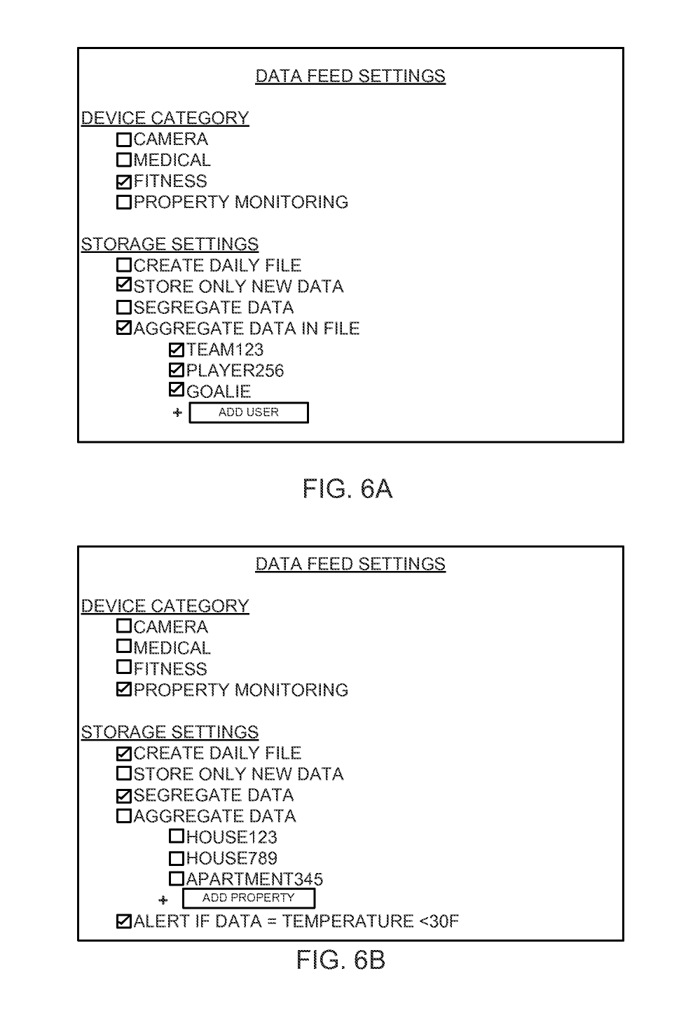

In addition to controlling how user device data is shared, the web-based storage system can control how the device data streams are received by recipients. FIGS. 6A and 6B depict diagrams of a user interface for data feed settings for a recipient. Generally speaking, a recipient will have a user account with the web-based storage system and can access the data stream using a computer or mobile device. An exemplary user interface can include settings for how to handle data from different devices and sources. For example, as shown in FIG. 6A, a coach can specify that fitness data should only be stored if it is new data, and that all fitness data should be aggregated for certain athletes. In this scenario, all of the fitness data for the selected athletes may be stored in one file or folder on the web-based storage system. In another example, as shown in FIG. 6B, a property manager may specify that all data is stored in a daily file and is segregated per property rather than aggregated. In addition, an alert may be created if a data point, such as temperature, exceeds a certain limit. Such exemplary data feed settings may be used to manage incoming data from the web-based storage system. In addition, a recipient can choose to block data from being received from a specified data source. In general, user data settings would have greater controls over the data than would be permitted for the recipients. For example, if a user specified another user or recipient as a viewer of data, the recipient would not be able override his or her role and specify some other data privileges.

While various embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A method for sharing data uploaded to a web-based storage system from a plurality of user devices, the method comprising:
detecting, using a processor, a connection of a user device for a first user to the web-based storage system;
determining, using the processor, a sharing setting associated with the user device;
uploading data, using the processor, stored on the user device to the web-based storage system; and
automatically sharing, using the processor, the uploaded data in accordance with the sharing setting for the user device.

2. The method of claim 1, further comprising verifying user data, using the processor, associated with an account for the first user on the web-based storage system that is associated with the user device.

3. The method of claim 2, wherein verifying the user data comprises:
retrieving user data previously stored in cache memory on the user device; or receiving user input on the user device, the user input including user data associated with the first user's account.

4. The method of claim 1, further comprising establishing a communications protocol between the user device and an application programming interface associated with the web-based storage system.

5. The method of claim 1, wherein the sharing setting specifies at least one of the group of:
a second user to share the uploaded data, a time schedule to share the uploaded data, on-demand sharing, and no user to share the uploaded data.

6. The method of claim 1, wherein automatically sharing the uploaded data comprises making the uploaded data available at least one second user specified in the sharing setting.

7. The method of claim 6, further comprising, limiting use of the uploaded data by the at least one second user in accordance with the sharing setting for the user device.

8. The method of claim 1, further comprising only sharing a portion of the uploaded data in accordance with the sharing setting for the user device.

9. The method of claim 5, further comprising: determining a data feed setting for the specified at least one second user; and sharing the uploaded data with the at least one second user in accordance with the data feed setting.

10. The method of claim 9, further comprising aggregating the uploaded data for the at least one second user with data uploaded by a second user device in accordance with the data feed setting and a second sharing setting associated with the second user device.

11. The method of claim 1 further comprising, comparing the uploaded data from the user device and prior data received from the user device and discarding any duplicate data prior to sharing the uploaded data in accordance with the sharing settings.

12. A system for sharing data uploaded to a web-based storage system from a plurality of user devices, the system comprising:
a server connected to the web-based storage system, the server configured to:
determine a sharing setting associated with a user device of a first user;
upload data stored on the user device to the web-based storage system; and
automatically share the uploaded data in accordance with the sharing setting for the user device.

13. The system of claim 12, wherein the server is further configured to verify user data associated with a user's account for the first user on the web-based storage system that is associated with the user device.

14. The system of claim 13, wherein verifying the user data comprises:
retrieving user data previously stored in cache memory on the user device; or
receiving user input on the user device, the user input including user data associated with the user's account for the first user.

15. The system of claim 12, wherein the server is further configured to establish a communications protocol between the user device and an application programming interface associated with the web-based storage system.

16. The system of claim 12, wherein the sharing setting specifies at least one of the group of:
a second user to share the uploaded data, a time schedule to share the uploaded data, on-demand sharing, and no user to share the uploaded data.

17. The system of claim 12, wherein automatically share the uploaded data comprises making the uploaded data available at least one second user specified in the sharing setting.

18. The system of claim 17, wherein the server is further configured to limit use of the uploaded data by the at least one second user in accordance with the sharing setting for the user device.

19. The system of claim 12, wherein the server is further configured to share only a portion of the uploaded data in accordance with the sharing setting for the user device.

20. The system of claim 16, wherein the server is further configured to determine a data feed setting for the specified at least one second user; and share the uploaded data with the at least one second user in accordance with the data feed setting.

21. The system of claim 20, wherein the server is further configured to aggregate the uploaded data for the at least one second user with data uploaded by a second user device in accordance with the data feed setting and a second sharing setting associated with the second user device.

22. The system of claim 12 wherein the server is further configured to compare the uploaded data from the user device and prior data received from the user device and discard any duplicate data prior to sharing the uploaded data in accordance with the sharing settings.
